(19) United States
(12) Patent Application Publication
(10) Pub. No.: US 2007/0041406 A1
(43) Pub. Date: Feb. 22, 2007

(54) Method for approval of time-dependent stream in residential Ethernet system

(75) Inventors: Sihai Wang, Suwon-si (KR); Sang-Ho Kim, Hwaseong-si (KR); Young-Hun Joo, Yongin-si (KR); Jae-Hun Cho, Seoul (KR); Yun-Je Oh, Yongin-si (KR); Fei-Fei Feng, Suwon-si (KR)

Correspondence Address: CHA & REITER, LLC, 210 ROUTE 4 EAST STE 103, PARAMUS, NJ, 07652, US

(73) Assignee: Samsung Electronics Co.; Ltd.

(21) Appl. No.: 11/506,135

(22) Filed: Aug. 17, 2006

(30) Foreign Application Priority Data
Aug. 18, 2005 (KR) 2005-75720

(51) Int. Cl. H04J 3/06

(52) U.S. Cl. 370/503

(57) ABSTRACT

Disclosed is a method for approval of a time-dependent stream input to a predetermined node in a residential Ethernet system, the method including the steps of receiving a transmission request of the time-dependent stream by the predetermined node, extracting a pacing parameter and a cycle number, which are a delay value of the predetermined node and a transmission period of the time-dependent stream, respectively, from the transmission-requested time-dependent stream, calculating a transmission bandwidth of an entire time-dependent stream to be transmitted through the predetermined node, by taking into consideration the pacing parameter and the cycle number, determining if the transmission bandwidth, which includes the transmission-requested time-dependent stream, satisfies a total transmission bandwidth based on the pacing parameter and the cycle number and determining whether to approve the transmission-requested time-dependent stream.

### CLAIM OF PRIORITY

This application claims the benefit of the earlier filing date, under 35 U.S.C. 119(a), to that patent application entitled “Method For Approval Of Time-Dependent Stream In Residential Ethernet System” filed in the Korean Intellectual Property Office on Aug. 18, 2005 and assigned Serial No. 2005-75720, the entire contents of which are incorporated herein by reference.

### BACKGROUND OF THE INVENTION

1. Field of the Invention

The present invention relates to residential Ethernet, and more particularly to a method for determining whether to approve a new time-dependent stream input to a predetermined node in a residential Ethernet system.

2. Description of the Related Art

Ethernet is the most widely used local area network technology and is defined as a standard in the Institute Electrical of Electrical and Electronics Engineers (IEEE) 802.3. Ethernet has been originally developed by Xerox and has been further advanced by companies such as Xerox, Digital Equipment Corporation (DEC), Intel, etc. The Ethernet protocol is a technology used when data are transmitted among a plurality of terminals or users.

In the conventional Ethernet, competitive access is accomplished by means of a carrier sense multiple access/collision detection (CSMA/CD) protocol stipulated in the IEEE 802.3. In this protocol a service frame of an upper layer is converted to an Ethernet frame while maintaining an inter frame gap (IFG). The Ethernet frame is then transmitted. In this case, upper service frames are transmitted according to the creation sequence thereof, regardless of the frame type thereof.

Ethernet is known to be insufficient for transmitting a moving image or sound data susceptible to transmission delay, because the Ethernet employs the CSMA/CD scheme as every Ethernet frame is given the same priority and is competitively transmitted.

However, recently, as the transmission of moving images and sound data has gradually increased and their relative importance in data transmission has become greater, various methods have been proposed for removing such a problem caused by transmission delay in using the Ethernet scheme.

IEEE 802.3p protocol is one scheme conventionally-proposed in order to reduce time delay in the Ethernet. According to the IEEE 802.3p protocol, classification of service (COS) is allocated to data based on a priority. The IEEE 802.3p protocol provides a slightly improved effect with respect to time delay by allocating a priority to multimedia data, or the like to be transmitted, as compared with the conventional IEEE 802.3 Ethernet scheme. However, since the IEEE 802.3p scheme does not employ a procedure of requiring and allocating bandwidth for each data, a bandwidth manager for managing allocation of bandwidth is required, thereby increasing the size of a jitter buffer for such bandwidth management.

Another conventional transmission scheme refers to residential Ethernet, in which synchronous data and asynchronous data are separately transmitted during one transmission cycle.

Currently, the residential Ethernet has been regarded as the most promising method for the next-generation home networking intranet. Such residential Ethernet has been developed from the existing Ethernet, referred to as “Legacy Ethernet,” so as to transmit time-dependent synchronous data differently from the existing Ethernet. Therefore, when the transmission of time-dependent data is approved at a specific node of the residential Ethernet system, the performance for the time-dependent data, such as delay, jitter, transmission rate, and loss rate are to be ensured in all nodes. Accordingly, in the residential Ethernet, it is necessary to allocate and control a time-dependent bandwidth at each node.

FIG. 1 is a block diagram illustrating connection between nodes in a conventional Legacy Ethernet.

Referring to the conventional Legacy Ethernet shown in FIG. 1, node #1 11 transmits a predetermined Ethernet packet 101 to node #2 12. Switch #1 14 and switch #2 15 are located between the node #1 11 and the node #2 12. Although the switches 14 and 15 are shown as switches it would be recognized that each switch 14 or 15 may also be a node as they are located between the nodes 11 and 12 so as to connect the nodes 11 and 12 to each other.

In this illustrated case, when node #3 13 is connected to the switch #1 14 and a new Ethernet packet 102 is additionally transmitted from the node #3 13 to the switch #1 14, there is no need in the conventional Legacy Ethernet to consider approval for transmission or the like because the transmission of data is processed in the CSMA/CD scheme in the conventional Legacy Ethernet. However, in the case of the residential Ethernet in which time-dependent synchronous data are transmitted, when a new Ethernet packet is added as described above, it is necessary to selectively approve transmission of the packet so as to prevent the performance of the entire system with respect to time-dependent data from being degraded.

Such a basic concept has been proposed in IEEE 802.3RESG (Residential Ethernet Study Group). Particularly, according to the David James White Paper of the Residential Ethernet Study group, a cycle based on a pacing approach is used to control the transmission approval for a time-dependent packet. Through such a concept, a bandwidth of each time-dependent stream can be expressed by using the number of bytes in a cycle, and the transmission approval is easily controlled based on an accumulated stream bandwidth. Generally, an accumulated time-dependent link bandwidth (or the number of bytes in one cycle) is limited to 75% of a line/bridge capacity (or the maximum number of bytes in one cycle).

FIG. 2 represents a diagram illustrating a rate of time-dependent data in one cycle in the conventional residential Ethernet.

The rate 21 of time-dependent data in one cycle 23 is about 75% of the entire cycle. The remaining portion is the rate 22 of time-independent data.

Every stream uses the same transmission cycle in a residential Ethernet system. Also, it is regarded that packets having the same number of bytes (or having a smaller number of bytes than that of a requested or given section) are transmitted during each transmission cycle. This means that one inequality as shown in Equation 1 must be satisfied for control of approval with respect to a transmission request for new time-dependent data at a predetermined node. Equation 1, which is based on the above referred-to David James paper, means that a sum of maximum bandwidths of time-dependent streams during one cycle must not exceed “a line speed×a bandwidth rate of the time-dependent streams in the entire cycle”.

$${\sum }_{n = 1}^{N} {B}_{n}^{max} \leq r \times l , \\ or \\ {\sum }_{n = 1}^{N} {S}_{n}^{max} \leq r \times {S}_{Cycle} \qquad ( 1 )$$

where “N” represents the total number of time-dependent streams,
“Bₙ^{max}” represents the maximum bandwidth of an n^{th} time-dependent stream for all cycles,
“l” represents a line speed (i.e. 100 Mbps in fast Ethernet, and 1 Gbps in Gigabit Ethernet),
“S” represents the number of bytes in one cycle, and
“r” represents a bandwidth rate of time-dependent streams in the entire link capacity (generally, 75%).

As described above, according to the prior art, a transmission approval request is processed on a condition that the maximum bandwidth of time-dependent streams during each cycle cannot exceed a rate of “r” with respect to a line speed.

However, such processing can be useful only for streams having an equal size, but cannot be applied to variable bit-rate (VBR) streams or burst-mode streams, in which traffic is not periodic or has a rapid change in size. In addition, it is difficult to apply the conventional processing scheme, when pacing parameters in consideration of a delay caused while a packet is input to or output from each node are different or when transmission periods of streams are different.

### SUMMARY OF THE INVENTION

Accordingly, the present invention has been made to solve the above-mentioned problems occurring in the prior art and provides additional advantages, by providing a method for approval of a time-dependent stream transmitted between nodes in a residential Ethernet system, which determines whether to approve the time-dependent stream by taking into consideration a pacing parameter and a cycle number with respect to the time-dependent stream.

In accordance with one aspect of the present invention, there is provided a method for approval of a time-dependent stream input to a predetermined node in a residential Ethernet system, the method including the steps of receiving a transmission request of the time-dependent stream by the predetermined node, extracting a pacing parameter and a cycle number, which are a delay value of the predetermined node and a transmission period of the time-dependent stream, respectively, from the transmission-requested time-dependent stream, calculating a transmission bandwidth of an entire time-dependent stream to be transmitted through the predetermined node, by taking into consideration a pacing parameter and a cycle number, determining if the transmission bandwidth, which includes the transmission-requested time-dependent stream satisfies a total transmission bandwidth and determining whether to approve the transmission-requested time-dependent stream.

### BRIEF DESCRIPTION OF THE DRAWINGS

The above features and advantages of the present invention will be more apparent from the following detailed description taken in conjunction with the accompanying drawings, in which:

FIG. 1 represents a block diagram illustrating connection between nodes in the conventional Legacy Ethernet;

FIG. 2 represents a diagram illustrating the section of time-dependent data in one cycle in the conventional residential Ethernet;

FIGS. 3A to 3C represent views for explaining a pacing parameter and a cycle number in residential Ethernet according to an embodiment of the present invention;

FIG. 4 represents a flowchart illustrating the procedure for approving transmission of a time-dependent stream in a predetermined node in a residential Ethernet system according to an embodiment of the present invention; and

FIG. 5 represents a diagram illustrating bandwidths based on a pacing parameter in the approval method according to an embodiment of the present invention.

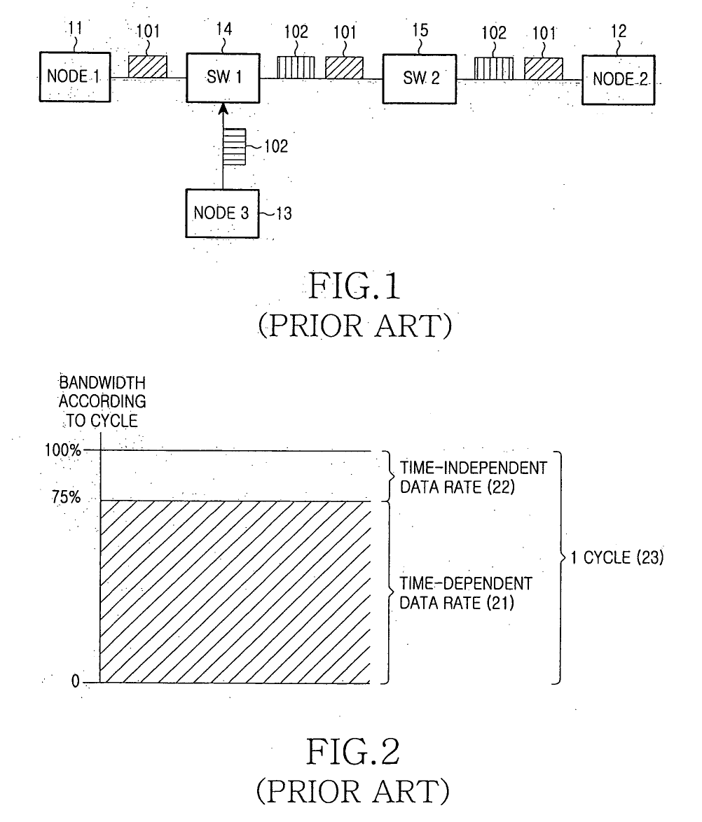

### DETAILED DESCRIPTION OF THE INVENTION

Hereinafter, an embodiment of the present invention will be described with reference to the accompanying drawings. For the purposes of clarity and simplicity, a detailed description of known functions and configurations incorporated herein will be omitted as it may obscure the subject matter of the present invention.

In the following description, time-dependent data and a time-dependent stream represent a time-sensitive frame, and time-independent data represent a best-effort frame. Although these representations are used together in the following description, it should be noted that time-dependent data and a time-dependent stream mean a time-sensitive frame, and time-independent data mean a best-effort frame.

As described above, the existing approval processing for a time-dependent stream using Equation 1 is performed without taking into consideration a change in a pacing parameter and a cycle number.

Before the description of the present invention, it should be noted that a pacing parameter represents the number of cycles delayed until a packet input to a node is output from the node, and a cycle number represents a cycle period in which a time-dependent stream is transmitted. In the following description, a cycle number and a pacing parameter are used as the above-mentioned meanings.

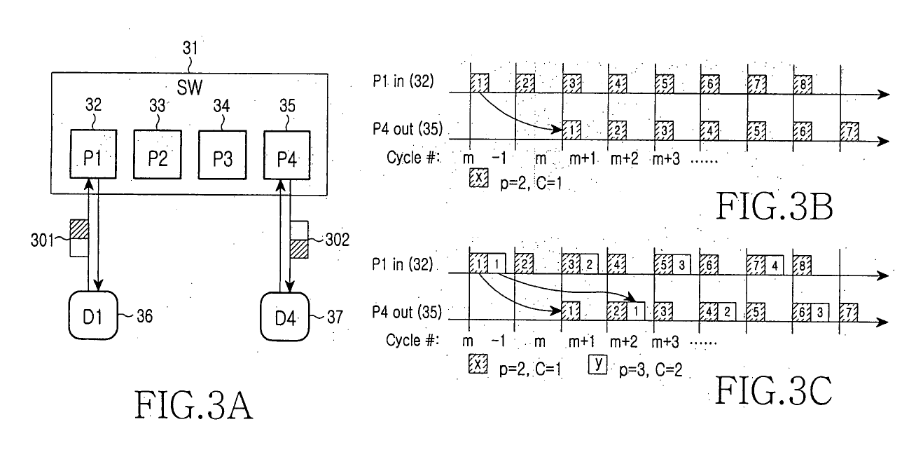

FIGS. 3A to 3C represent views for explaining a pacing parameter and a cycle number in residential Ethernet according to an embodiment of the present invention.

FIG. 3A is a block diagram illustrating the construction of a switch 31 in the residential Ethernet according to an embodiment of the present invention. Switch 31 includes four ports 32, 33, 34, and 35. According to the embodiment of the present invention, the switch 31 receives data 301 through port #1 32 from an external node D1 36, and outputs corresponding data 302 through port #4 35 to an external node D4 37. Herein, reference numerals 301 and 302 represent the same data, and are indicated by different reference numerals only for convenience of description.

FIG. 3B is a timing diagram for explaining a case of processing a single stream.

In FIG. 3B, the stream has a pacing parameter “p” of “2” and a cycle period “C” of “1”. Therefore, data of the stream are transmitted every cycle as the cycle period is “1”, and two cycles are consumed for processing data from an input port #1 32 to an output port #4 35 as the pacing parameter is “2”. That is, when a portion of a stream is input during an (m−1)^{th} cycle, the portion of the stream is output during an (m+1)^{th} cycle.

FIG. 3C represents a timing diagram for explaining a case of processing two streams.

In FIG. 3C, a first stream “x” (represented as hashed blocks) has a pacing parameter “p” of “2” and a cycle period “C” of “1”, and a second stream “y” (represented as clear blocks) has a pacing parameter “p” of “3” and a cycle period “C” of “2”. The data of the first stream “x” are transmitted every cycle as the cycle period thereof is “1”, and two cycles are consumed for processing data from an input port #1 32 to an output port #4 35 as the pacing parameter is “2”. Thus, when a portion of the “x” stream is input during an (m−1)^{th} cycle, the portion of the stream is output during an (m+1)^{th} cycle. In addition, data of the second stream “y” are transmitted every two cycles as the cycle period thereof is “2”, and three cycles are consumed for processing data from an input port #1 32 to an output port #4 35 as the pacing parameter thereof is “3”. That is, when a portion of the second stream is input during an (m−1)^{th} cycle, the portion of the second stream is output during an (m+2)^{th} cycle. Then, the next portion of the second stream is processed and outputted during an (m+4)^{th} cycle.

Accordingly, in the case of FIG. 3C, bandwidths required at each cycle are not uniform. Therefore, all of the non-uniform bandwidths must be considered when approving a time-dependent stream. The approval may be determined by using Equations 2, as stated below:

$${\sum }_{n = 1}^{N} {B}_{n}^{max} \leq r \times l \\ {\sum }_{n = 1}^{N} {C}_{n} \cdot {B}_{n}^{max} \leq ( p - \frac{{T}_{Async\_MTU}}{{T}_{Cycle}} ) \times l \qquad ( 2 )$$

wherein “N” represents the total number of time-dependent streams,
“Bₙ^{max}” represents the maximum bandwidth of an n^{th} time-dependent stream for all cycles,
“l” represents a line speed (i.e. 100 Mbps in fast Ethernet, and 1 Gbps in Gigabit Ethernet),
“r” represents a bandwidth rate of time-dependent streams in the entire link capacity (generally, 75%),
“Cₙ” represents a ratio of a packet period to a basic cycle time,
“p” represents a pacing constant,
“T_{Async}_{_{—}}_{MTU}” represents the transmission time period of the maximum Legacy Ethernet frame (including all overheads, e.g. 123 μs in fast Ethernet and 12.3 μs in Gigabit Ethernet), and
“T_{Cycle}” represents a cycle time period (125 μs).

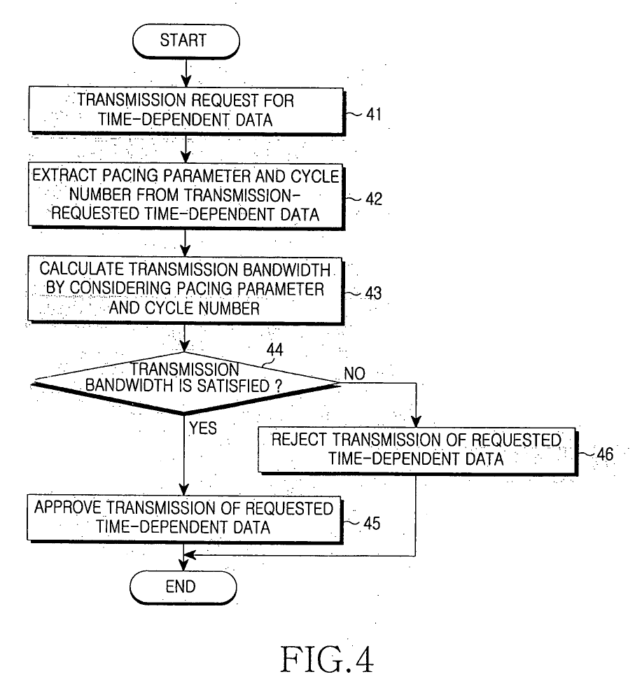

FIG. 4 is a flowchart illustrating the procedure for approving transmission of a time-dependent stream in a node in a residential Ethernet system according to an embodiment of the present invention.

First, a node receives a request for transmission of time-dependent data, in addition to time-dependent data being currently transmitted, (step 41). In step 42, a pacing parameter “p” and a cycle number “C”, which are information about a period, are extracted from the transmission-requested time-dependent data.

In step 43, a transmission bandwidth is calculated by taking into consideration the pacing parameter and the cycle number.

In this case, the transmission bandwidth may be calculated by Equation 2, in one aspect of the invention. In a preferred aspect of the invention, the transmission bandwidth may be calculated by Equation 3 which is proposed as a more generalized equation according to an embodiment of the present invention.

$${\sum }_{q = 1}^{Q} {\sum }_{n = 1}^{{N}_{q}} {B}_{q , n}^{max} \leq l \\ {\sum }_{q = 1}^{Q} {\sum }_{n = 1}^{{N}_{q}} {B}_{q , n}^{ave} \leq r \times l \\ {\sum }_{q = 1}^{m} {\sum }_{n = 1}^{{N}_{q}} {C}_{q , n} {B}_{q , n}^{max} + {p}_{m} \times {\sum }_{q = 1}^{m - 1} {\sum }_{n = 1}^{{N}_{q}} {B}_{q , n}^{max} \leq ( {p}_{m} - \frac{{T}_{Async\_MTU}}{{T}_{Cycle}} ) \times l \\ ( m = 1 … Q ) \qquad ( 3 )$$

wherein, “N_{q}” represents the total number of time-dependent streams according to levels,
“B_{q,n}^{max}” represents the maximum bandwidth of an n^{th} time-dependent stream for all cycles,
“B_{q,n}^{ave}” represents the average bandwidth of an n^{th} time-dependent stream for all cycles,
“l” represents a line speed (i.e. 100 Mbps in fast Ethernet, and 1 Gbps in Gigabit Ethernet),
“r” represents a bandwidth rate of time-dependent streams in the entire link capacity (generally, 75%),
“Cₙ” represents a ratio of a packet period to a basic cycle time,
“pₘ” represents a pacing constant for each level, “T_{Async}_{_{—}}_{MTU}” represents the transmission time period of the maximum Legacy Ethernet frame (including all overheads, e.g. 123 μs in fast Ethernet and 12.3 μs in Gigabit Ethernet),
“T_{Cycle}” represents a cycle time period (125 μs),
“m” represents a level value according to the size of the pacing constant, and
“Q” represents the maximum value of the pacing constant.

Referring to Equation 3, it can be recognized that a variable bit-rate (VBR) and a burst mode can be supported by defining a bandwidth with respect to a sum of average values and to a sum of maximum values based on the first and second expressions in Equation 3. That is, since the VBR and burst mode correspond to the case in which the maximum value of bandwidths differs from the average value of the bandwidths, a sum of maximum values is expanded to the value of “line speed” while a sum of average values is limited to the value of “line speed×r” in Equation 3.

Also, in operation of the entire bandwidth, the value of pacing parameter “p” in Equation 3, unlike Equation 2, is not fixed but is changed according to levels, so that the approval method according to the present invention can be applied even when a time-dependent stream having varying pacing parameters is received.

The third expression in Equation 3 will now be described in more detail. All input time-dependent streams are grouped into Q levels according to pacing parameters thereof. Therefore, a group of level “m” includes Nₘ time-dependent streams. That is, every stream belongs to one level having a pacing parameter “pₘ” (p₁<p₂<p₃ . . .<p_{q}). In this case, streams belonging to an equal level have the same pacing parameter but may have different cycle numbers.

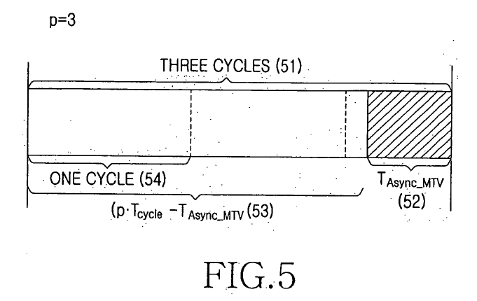

Therefore, on the left side of the first expression in Equation 3, the first term represents a sum of bandwidths without taking delay into consideration, and the second term represents a sum of bandwidths taking delay into consideration. Accordingly, when there is a predetermined delay, the entire term of the left side becomes a sum of total bandwidths in “predetermined delay×cycle”. Such a sum of total bandwidths will now be described with reference to FIG. 5.

FIG. 5 is a diagram illustrating bandwidths according to delay in the approval method according to an embodiment of the present invention.

When a pacing parameter has a value of “3”, a range expanded to three cycles 51 is considered in order to apply the approval method. That is, it is necessary to satisfy the remaining term “p×T_{cycle}−T_{Async}_{_{—}}_{MTU}”, except for the maximum transmission region 52 for time-independent data, in the three cycles.

A transmission bandwidth is calculated in equation 2 or 3 (step 43), and it is determined if the calculated transmission bandwidth satisfies the corresponding equation (step 44).

When it is determined that the calculated transmission bandwidth satisfies the corresponding equation, the predetermined node approves the transmission of the requested time-dependent data (step 45).

In contrast, when it is determined that the calculated transmission bandwidth does not satisfy the corresponding equation, the predetermined node rejects the transmission of the requested time-dependent data (step 46).

Through such a procedure, each node (or each switch) can determine whether to approve the transmission of received time-dependent data.

Herein, Equation 3, which provides a decisive basis for determining whether to approve transmission according to the present invention, may be changed to various schemes.

In one aspect of the invention, bandwidth may be expressed using the total number of bytes transmitted during each cycle as:
B=S/(C×T_{cycle}) (4)

wherein “B” represents a bandwidth,
“S” represents the number of packet bytes in a cycle,
“C” represents a cycle number, and
“T_{cycle}” represents a cycle time (i.e. 125 μs).

Equation 5, which is modified from Equation 3, is obtained by substituting a bandwidth “B” with the number “S” of packet bytes.

$${\sum }_{q = 1}^{Q} {\sum }_{n = 1}^{{N}_{q}} \frac{{S}_{q , n}^{max}}{{C}_{q , n}} \leq {S}_{Cycle} \\ {\sum }_{q = 1}^{Q} {\sum }_{n = 1}^{{N}_{q}} \frac{{S}_{q , n}^{ave}}{{C}_{q , n}} \leq r \times {S}_{Cycle} \\ {\sum }_{q = 1}^{m} {\sum }_{n = 1}^{{N}_{q}} {S}_{q , n}^{max} + {p}_{m} \times {\sum }_{q = 1}^{m - 1} {\sum }_{n = 1}^{{N}_{q}} \frac{{S}_{q , n}^{max}}{{C}_{q , n}} \leq {p}_{m} \times {S}_{Cycle} - {S}_{Async\_MTU} \\ ( m = 1 … Q ) \qquad ( 5 )$$

wherein, “S_{cycle}” is equal to “l×T_{cycle}”, and
“S_{Async}_{_{—}}_{MTU}” represents the number of bytes of the maximum Legacy Ethernet frame in one cycle time.

The IEE 802.3 standard defines “S_{Async}_{_{—}}_{MTU}” as 1538 bytes when a VLAN tag field is not included, and as 1542 bytes when a VLAN tag field is included.

In the above Equations, the parameters of “r”, “l”, “T_{Async}_{_{—}}_{MTU}”, and “T_{cycle}” may be set in advance. When it is necessary to set a time-dependent connection, each of “Bₙ^{ave}”, “Cₙ”, “pₘ” and “Bₙ^{max}/Bₙ^{ave}” (or Bₙ^{max}) are provided upon a corresponding connection request. Therefore, whether to approve transmission of time-dependent data is determined based on whether Equation 3 (or Equation 5) is satisfied by using the provided parameters and preset parameters, as described above.

When “Q” has a value of “1” and “Bₙ^{ave}” is replaced with “Bₙ^{max}” in Equation 3, Equation 3 is converted to the same as Equation 2 (the same can be said for Equation 5).

Also, when “Bₙ^{ave}” is replaced with “Bₙ^{max}”, Equation 3 is modified to Equation 6.

$${\sum }_{q = 1}^{Q} {\sum }_{n = 1}^{{N}_{q}} {B}_{q , n}^{max} \leq r \times l \\ {\sum }_{q = 1}^{m} {\sum }_{n = 1}^{{N}_{q}} {C}_{q , n} {B}_{q , n}^{max} + {p}_{m} \times {\sum }_{q = 1}^{m - 1} {\sum }_{n = 1}^{{N}_{q}} \leq ( {p}_{m} - \frac{{T}_{Async\_MTU}}{{T}_{Cycle}} ) \times l \\ ( m = 1 … Q ) \qquad ( 6 )$$

In addition, when cycle number “C” is set to “1”, Equation 3 can be simplified as Equation 7.

$${\sum }_{q = 1}^{Q} {B}_{q}^{max} \leq l \\ {\sum }_{q = 1}^{Q} {B}_{q}^{ave} \leq r \times l \\ {\sum }_{q = 1}^{m} {B}_{q}^{max} + {p}_{m} \times {\sum }_{q = 1}^{m - 1} {B}_{q}^{max} \leq ( {p}_{m} - \frac{{T}_{Async\_MTU}}{{T}_{Cycle}} ) \times l \\ ( m = 1 … Q ) \qquad ( 7 )$$

Also, when “Bₙ^{ave}”, is replaced with “Bₙ^{max}”, Equation 7 is modified as Equation 8.

$${\sum }_{q = 1}^{Q} {B}_{q}^{max} \leq r \times l \\ {\sum }_{q = 1}^{m} {B}_{q}^{max} + {p}_{m} \times {\sum }_{q = 1}^{m - 1} {B}_{q}^{max} \leq ( {p}_{m} - \frac{{T}_{Async\_MTU}}{{T}_{Cycle}} ) \times l \\ ( m = 1 … Q ) \qquad ( 8 )$$

If all time-dependent streams have an equal pacing parameter “p” (i.e. if there is only a single level and thus “Q” has a value of “1”), Equation 3 is modified to Equation 9.

$${\sum }_{n = 1}^{N} {B}_{n}^{max} \leq l \\ {\sum }_{n = 1}^{N} {B}_{n}^{ave} \leq r \times l \\ {\sum }_{n = 1}^{N} {C}_{n} {B}_{n}^{max} \leq ( p - \frac{{T}_{Async\_MTU}}{{T}_{Cycle}} ) \times l \qquad ( 9 )$$

When bandwidth is replaced with the number of bytes, Equation 9 becomes Equation 10.

$${\sum }_{n = 1}^{N} \frac{{S}_{n}^{max}}{{C}_{n}} \leq {S}_{Cycle} \\ {\sum }_{n = 1}^{N} \frac{{S}_{n}^{ave}}{{C}_{n}} \leq r \times {S}_{Cycle} \\ {\sum }_{n = 1}^{N} {S}_{n}^{max} \leq p \times {S}_{Cycle} - {S}_{Async\_MTU} \qquad ( 10 )$$

The method according to the present invention can be realized by a program and can be stored in a recording medium (such as a CD ROM, a RAM, a floppy disk, a hard disk, a magneto-optical disk, etc.) in a format that can be read by a computer. Or may be downloaded via an electronic means over a network.

According to the present invention as described above, when a node receives a specific time-dependent stream in a residential Ethernet system, the node can determine whether to approve transmission of the time-dependent stream.

Particularly, the present invention normalizes a pacing parameter and a cycle number, so that it is possible to perform a normalized approval determination even with respect to a VBR stream and a burst-mode stream.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for approving a time-dependent stream input to a node in a residential Ethernet system, the method comprising the steps of:
a) receiving a transmission request of the time-dependent stream by the node;
b) extracting a pacing parameter and a cycle number, which are a delay value of the node and a transmission period of the time-dependent stream, respectively, from the transmission-requested time-dependent stream;
c) calculating a transmission bandwidth of an entire time-dependent stream to be transmitted through the node, by taking into consideration the pacing parameter and the cycle number;
d) determining if the transmission bandwidth, which includes the transmission-requested time-dependent stream satisfies a total transmission bandwidth; and
e) determining whether to approve the transmission-requested time-dependent stream.

2. The method as claimed in claim 1, wherein the determination of transmission bandwidth is performed based on the following:
$${\sum }_{q = 1}^{Q} {\sum }_{n = 1}^{{N}_{q}} {B}_{q , n}^{max} \leq l$$
$${\sum }_{q = 1}^{Q} {\sum }_{n = 1}^{{N}_{q}} {B}_{q , n}^{ave} \leq r \times l$$
$${\sum }_{q = 1}^{m} {\sum }_{n = 1}^{{N}_{q}} {C}_{q , n} {B}_{q , n}^{max} + {p}_{m} \times {\sum }_{q = 1}^{m - 1} {\sum }_{n = 1}^{{N}_{q}} {B}_{q , n}^{max} \leq ( {p}_{m} - \frac{{T}_{Async\_MTU}}{{T}_{Cycle}} ) \times l \\ ( m = 1 … Q ) ,$$
wherein
“N_{q}” represents a total number of time-dependent streams according to levels,
“B_{q,n}^{max}” represents a maximum bandwidth of an n^{th} time-dependent stream for all cycles,
“B_{q,n}^{ave}” represents an average bandwidth of an n^{th} time-dependent stream for all cycles,
“l” represents a line speed (i.e. 100 Mbps in fast Ethernet, and 1 Gbps in Gigabit Ethernet),
“r” represents a bandwidth rate of time-dependent streams in an entire link capacity (generally, 75%),
“Cₙ” represents a ratio of a packet period to a basic cycle time,
“pₘ” represents a pacing constant for each level,
“T_{Async}_{_{—}}_{MTU}” represents a transmission time period of a maximum Legacy Ethernet frame (including all overheads, e.g. 123 μs in fast Ethernet and 12.3 μs in Gigabit Ethernet),
“T_{Cycle}” represents a cycle time (125 μs),
“m” represents a level value according to the size of the pacing constant, and
“Q” represents a maximum value of the pacing constant.

3. The method as claimed in claim 2, wherein “B” is represented as: B=S/(C×T_{cycle})
wherein “B” represents a bandwidth,
“S” represents the number of packet bytes in a cycle,
“C” represents a cycle number, and
“T_{cycle}” represents a cycle time (i.e. 125 μs).

4. The method as claimed in claim 3, wherein the determination of transmission bandwidth is performed based on the following:
$${\sum }_{q = 1}^{Q} {\sum }_{n = 1}^{{N}_{q}} \frac{{S}_{ q , n}^{ max}}{{C}_{q , n}} \leq {S}_{Cycle}$$
$${\sum }_{q = 1}^{Q} {\sum }_{n = 1}^{{N}_{q}} \frac{{S}_{ q , n}^{ ave}}{{C}_{q , n}} \leq r \times {S}_{Cycle}$$
$${\sum }_{q = 1}^{m} {\sum }_{n = 1}^{{N}_{q}} {S}_{ q , n}^{ max} + {p}_{m} \times {\sum }_{q = 1}^{m - 1} {\sum }_{n = 1}^{{N}_{q}} \frac{{S}_{ q , n}^{ max}}{{C}_{q , n}} \leq {p}_{m} \times {S}_{Cycle} - {S}_{Async\_MTU} ( m = 1 … Q ) ,$$
wherein,
“S_{cycle}” is equal to “l×T_{cycle}”, and
“S_{Async}_{_{—}}_{MTU}” represents a number of bytes of the maximum Legacy Ethernet frame in one cycle time.

5. The method as claimed in claim 2, wherein values of “Bₙ^{ave}”, “Cₙ”, “pₘ” and “Bₙ^{max}/Bₙ^{ave}” are obtained in a procedure of receiving the transmission request of the time-dependent stream.

6. An apparatus for approving a time-dependent stream input to a node in a residential Ethernet system, the apparatus comprising:
a processor in communication with a memory, the processor executing code for executing the steps of:
a) receiving a transmission request of the time-dependent stream by the node;
b) extracting a pacing parameter and a cycle number, which are a delay value of the node and a transmission period of the time-dependent stream, respectively, from the transmission-requested time-dependent stream;
c) calculating a transmission bandwidth of an entire time-dependent stream to be transmitted through the node, by taking into consideration the pacing parameter and the cycle number;
d) determining if the transmission bandwidth, which includes the transmission-requested time-dependent stream satisfies a total transmission bandwidth; and
e) determining whether to approve the transmission-requested time-dependent stream.

7. The apparatus as claimed in claim 6, wherein the determination of transmission bandwidth is performed based on the following:
$${\sum }_{q = 1}^{Q} {\sum }_{n = 1}^{{N}_{q}} {B}_{q , n}^{max} \leq l$$
$${\sum }_{q = 1}^{Q} {\sum }_{n = 1}^{{N}_{q}} {B}_{q , n}^{ave} \leq r \times l$$
$${\sum }_{q = 1}^{m} {\sum }_{n = 1}^{{N}_{q}} {C}_{q , n} {B}_{ q , n}^{ max} + {p}_{m} \times {\sum }_{q = 1}^{m - 1} {\sum }_{n = 1}^{{N}_{q}} {B}_{ q , n}^{ max} \leq ( {p}_{m} - \frac{{T}_{Async\_MTU}}{{T}_{Cycle}} ) \times l ( m = 1 … Q ) ,$$
wherein
“N_{q}” represents a total number of time-dependent streams according to levels,
“B_{q,n}^{max}” represents a maximum bandwidth of an n^{th} time-dependent stream for all cycles,
“B_{q,n}^{ave}” represents an average bandwidth of an n^{th} time-dependent stream for all cycles,
“l” represents a line speed (i.e. 100 Mbps in fast Ethernet, and 1 Gbps in Gigabit Ethernet),
“r” represents a bandwidth rate of time-dependent streams in an entire link capacity (generally, 75%),
“Cₙ” represents a ratio of a packet period to a basic cycle time,
“pₘ” represents a pacing constant for each level,
“T_{Async}_{_{—}}_{MTU}” represents a transmission time period of a maximum Legacy Ethernet frame (including all overheads, e.g. 123 μs in fast Ethernet and 12.3 μs in Gigabit Ethernet),
“T_{Cycle}” represents a cycle time (125 μs),
“m” represents a level value according to the size of the pacing constant, and
“Q” represents a maximum value of the pacing constant.

8. The apparatus as claimed in claim 7, wherein “B” is represented as:
B=S/(C×T_{cycle})
wherein “B” represents a bandwidth,
“S” represents the number of packet bytes in a cycle,
“C” represents a cycle number, and
“T_{cycle}” represents a cycle time (i.e. 125 μs).

9. The apparatus as claimed in claim 8, wherein the determination of transmission bandwidth is performed based on the following:
$${\sum }_{q = 1}^{Q} {\sum }_{n = 1}^{{N}_{q}} \frac{{S}_{ q , n}^{ max}}{{C}_{q , n}} \leq {S}_{Cycle}$$
$${\sum }_{q = 1}^{Q} {\sum }_{n = 1}^{{N}_{q}} \frac{{S}_{ q , n}^{ ave}}{{C}_{q , n}} \leq r \times {S}_{Cycle}$$
$${\sum }_{q = 1}^{m} {\sum }_{n = 1}^{{N}_{q}} {S}_{ q , n}^{ max} + {p}_{m} \times {\sum }_{q = 1}^{m - 1} {\sum }_{n = 1}^{{N}_{q}} \frac{{S}_{ q , n}^{ max}}{{C}_{q , n}} \leq {p}_{m} \times {S}_{Cycle} - {S}_{Async\_MTU} ( m = 1 … Q ) ,$$
wherein,
“S_{cycle}” is equal to “l×T_{cycle}”, and
“S_{Async}_{_{—}}_{MTU}” represents a number of bytes of the maximum Legacy Ethernet frame in one cycle time.

10. The apparatus as claimed in claim 6, wherein values of “Bₙ^{ave}”, “Cₙ”, “pₘ” and “Bₙ^{max}/Bₙ^{ave}” (or Bₙ^{max}) are obtained in a procedure of receiving the transmission request of the time-dependent stream.

11. The apparatus as claimed in claim 6, wherein the code is stored in the memory.

12. A computer-program product providing code to a processor for approving a time-dependent stream input to a node in a residential Ethernet system, the code instructing the processor to execute the steps of:
a) receiving a transmission request of the time-dependent stream by the node;
b) extracting a pacing parameter and a cycle number, which are a delay value of the node and a transmission period of the time-dependent stream, respectively, from the transmission-requested time-dependent stream;
c) calculating a transmission bandwidth of an entire time-dependent stream to be transmitted through the node, by taking into consideration the pacing parameter and the cycle number;
d) determining if the transmission bandwidth, which includes the transmission-requested time-dependent stream satisfies a total transmission bandwidth; and
e) determining whether to approve the transmission-requested time-dependent stream.

13. The computer-program product as claimed in claim 12, wherein the determination of transmission bandwidth is performed based on the following:
$${\sum }_{q = 1}^{Q} {\sum }_{n = 1}^{{N}_{q}} {B}_{q , n}^{max} \leq l$$
$${\sum }_{q = 1}^{Q} {\sum }_{n = 1}^{{N}_{q}} {B}_{q , n}^{ave} \leq r \times l$$
$${\sum }_{q = 1}^{m} {\sum }_{n = 1}^{{N}_{q}} {C}_{q , n} {B}_{ q , n}^{ max} + {p}_{m} \times {\sum }_{q = 1}^{m - 1} {\sum }_{n = 1}^{{N}_{q}} {B}_{ q , n}^{ max} \leq ( {p}_{m} - \frac{{T}_{Async\_MTU}}{{T}_{Cycle}} ) \times l ( m = 1 … Q ) ,$$
wherein
“N_{q}” represents a total number of time-dependent streams according to levels,
“B_{q,n}^{max}” represents a maximum bandwidth of an n^{th} time-dependent stream for all cycles,
“B_{q,n}^{ave}” represents an average bandwidth of an n^{th} time-dependent stream for all cycles,
“l” represents a line speed (i.e. 100 Mbps in fast Ethernet, and 1 Gbps in Gigabit Ethernet),
“r” represents a bandwidth rate of time-dependent streams in an entire link capacity (generally, 75%),
“Cₙ” represents a ratio of a packet period to a basic cycle time,
“pₘ” represents a pacing constant for each level,
“T_{Async}_{_{—}}_{MTU}” represents a transmission time period of a maximum Legacy Ethernet frame (including all overheads, e.g. 123 μs in fast Ethernet and 12.3 μs in Gigabit Ethernet),
“T_{Cycle}” represents a cycle time (125 μs),
“m” represents a level value according to the size of the pacing constant, and
“Q” represents a maximum value of the pacing constant.

14. The computer-program product as claimed in claim 13, wherein “B” is represented as:
B=S/(C×T_{cycle})
wherein “B” represents a bandwidth,
“S” represents the number of packet bytes in a cycle,
“C” represents a cycle number, and
“T_{cycle}” represents a cycle time (i.e. 125 μs).

15. The computer-program product as claimed in claim 14, wherein the determination of transmission bandwidth is performed based on the following:
$${\sum }_{q = 1}^{Q} {\sum }_{n = 1}^{{N}_{q}} \frac{{S}_{ q , n}^{ max}}{{C}_{q , n}} \leq {S}_{Cycle}$$
$${\sum }_{q = 1}^{Q} {\sum }_{n = 1}^{{N}_{q}} \frac{{S}_{ q , n}^{ ave}}{{C}_{q , n}} \leq r \times {S}_{Cycle}$$
$${\sum }_{q = 1}^{m} {\sum }_{n = 1}^{{N}_{q}} {S}_{ q , n}^{ max} + {p}_{m} \times {\sum }_{q = 1}^{m - 1} {\sum }_{n = 1}^{{N}_{q}} \frac{{S}_{ q , n}^{ max}}{{C}_{q , n}} \leq {p}_{m} \times {S}_{Cycle} - {S}_{Async\_MTU} ( m = 1 … Q ) ,$$
wherein,
“S_{cycle}” is equal to “l×T_{cycle}”, and
“S_{Async}_{_{—}}_{MTU}” represents a number of bytes of the maximum Legacy Ethernet frame in one cycle time.

16. The computer-program product as claimed in claim 12, wherein values of “Bₙ^{ave}”, “Cₙ”, “pₘ” and “Bₙ^{max}/Bₙ^{ave}” (or Bₙ^{max}) are obtained in a procedure of receiving the transmission request of the time-dependent stream.
